(19) United States
(12) Patent Application Publication
(10) Pub. No.: US 2010/0227571 A1
(43) Pub. Date: Sep. 9, 2010

(54) Antenna switch and radio communication device

(75) Inventor: Hideo Oota, Shiga (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/656,561

(22) Filed: Feb. 3, 2010

(30) Foreign Application Priority Data
Mar. 4, 2009 (JP) 2009-050259

(51) Int. Cl. H04B 1/44

(52) U.S. Cl. 455/78

(57) ABSTRACT

An antenna switch selectively connects one of a transmission signal terminal and a reception signal terminal to a common terminal, and includes a plurality of external terminals including the common terminal, the transmission signal terminal, and the reception signal terminal, a semiconductor chip having a plurality of terminals formed therein, and a plurality of bonding wires that connect the external terminals and the plurality of terminals formed in the semiconductor chip. Two bonding wires that are adjacent to each other among the plurality of bonding wires are used as directional couplers.

### INCORPORATION BY REFERENCE

This application is based upon and claims the benefit of priority from Japanese patent application No. 2009-050259, filed on Mar. 4, 2009, the disclosure of which is incorporated herein in its entirety by reference.

### BACKGROUND

1. Field of the Invention

The present invention relates to an antenna switch and a radio communication device, and more specifically, to an antenna switch that requires a directional coupler device and a radio communication device.

2. Description of Related Art

Radio communication equipments such as portable telephones have still been developed to increase their functions to offer high added value. Thus, further downsizing and cost reduction are required in the radio communication devices.

On the contrary, a directional coupler device mounted on a high-frequency radio communication device has interfered with downsizing and cost reduction. This is because the directional coupler device is embedded in a substrate of the high-frequency radio communication device and requires large individual high-frequency line.

FIG. 3 shows a block diagram of a high-frequency module 200 mounted on a radio communication device disclosed in Japanese Unexamined Patent Application Publication No. 2002-141827. The high-frequency module 200 includes a multiband high-frequency switch SW including a branch filter DIP10 that divides a plurality of transmitting and receiving systems having different passbands into each of a transmitting system and a receiving system and diode switch circuits SW10, SW20 for switching a transmitting system and a receiving system to each of transmitting/receiving systems. Further, the high-frequency module 200 includes directional coupler devices (couplers) COP10 and COP20 corresponding to each of passing frequencies in Tx terminal sides of the diode switch circuits SW10, SW20 to monitor outputs of the amplifiers AMP10, AMP20.

In receiving signals, a signal received from an antenna ANT is transmitted to a receiving terminal RX1 through the branch filter DIP10 and the switch SW10. On the other hand, in transmitting signals, a transmission signal amplified by the amplifier AMP10 is transmitted to the antenna ANT through a TX1 terminal, the directional coupler device COP10, the switch SW10, and the branch filter DIP10. At this time, the directional coupler device COP10 has a function of performing feedback on the transmission signal and controlling transmission output by an output control circuit APC.

Although no specific example is disclosed in Japanese Unexamined Patent Application Publication No. 2002-141827, the high-frequency module typically incorporates a directional coupler device and the like in a multi-layer substrate such as a low-temperature co-fired ceramic substrate, and mounts a semiconductor chip that functions as an antenna switch on the substrate, so as to realize downsizing.

Japanese Unexamined Patent Application Publication No. 2006-211199 discloses an example in which a directional coupler device is embedded in a substrate. FIG. 4 shows a block diagram showing a circuit configuration example of a high-frequency module 300 disclosed in Japanese Unexamined Patent Application Publication No. 2006-211199, and FIG. 5 shows a transparent perspective view of the high-frequency module 300 embedded in a dielectric substrate 209.

In FIGS. 4 and 5, a transmission signal terminal 204 is provided in an input side of a power amplifying element 202, and an output terminal 201 is provided in an output side of the power amplifying element 202 through a matching circuit 203. In this high-frequency module 300, the transmission signal input from the transmission signal terminal 204 is amplified by the power amplifying element 202 and is supplied to the output terminal 201 through the matching circuit 203. A transmission signal monitor terminal 205 is to extract the signal to a monitor circuit (not shown) in order to protect excessive output or to control transmission output level from the power amplifying element 202.

According to the structure disclosed in Japanese Unexamined Patent Application Publication No. 2006-211199, an inductance L201 pattern of the matching circuit 203 also functions as a primary line 211 of the directional coupler. As a result, the matching circuit 203 converts the output impedance of the power amplifying element 202 to 50 Ω and functions as a directional coupling circuit 206 for monitoring the output signal. Accordingly, the transmission signal monitor terminal 205 is connected to a secondary line 214 (L202) of the directional coupling circuit 206 while the inductance L201 pattern of the matching circuit 203 functions as the primary line 211.

### SUMMARY

According to the structure disclosed in Japanese Unexamined Patent Application Publication No. 2002-141827, downsizing can be realized compared with a method of mounting each element on a printed board. However, the present inventors have found a problem that, due to the forming of the directional coupling circuit in the multi-layer substrate, downsizing is inhibited due to the size of the multi-layer substrate. In Japanese Unexamined Patent Application Publication No. 2006-211199, there is no need to form the directional coupling circuit in another area as in the related art since the matching circuit 203 has a function as the directional coupling circuit 206 to monitor the output signal. As a result, downsizing in the circuit can be realized. However, in order to form the secondary line of the directional coupler 206, a wiring conductive layer needs to be formed as a strip line on the dielectric layer. In order to realize further downsizing which has been required in recent years, this line length itself needs to be downsized.

An antenna switch that selectively connects one of a transmission signal terminal and a reception signal terminal to a common terminal connected to an antenna, the antenna switch including a plurality of external terminals including the common terminal, the transmission signal terminal, and the reception signal terminal, a semiconductor chip having a plurality of terminals formed therein, and a plurality of bonding wires that connect the external terminals and the plurality of terminals formed in the semiconductor chip, in which two bonding wires that are adjacent to each other among the plurality of bonding wires are used as directional couplers.

According to the module configuration as disclosed in Japanese

Unexamined Patent Application Publication No. 2006-211199 in which the dielectric layer and the conductive layer are used, there is limitation in the distance between the primary line and the secondary line. Meanwhile, according to the present invention in which the bonding wires in the antenna switch are used as the lines, of the directional couplers, the distance between the primary line and the secondary line of the directional couplers can be decreased. In summary, by incorporating the directional couplers in the antenna switch, downsizing in the radio communication device can be realized.

According to the present invention, it is possible to provide an antenna switch and a radio communication device that realize downsizing.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing a circuit configuration example of an antenna switch according to an exemplary embodiment;

FIG. 2A is a plane view showing an assembled configuration example of the antenna switch according to the exemplary embodiment;

FIG. 2B is a transparent side view showing an assembled configuration example of the antenna switch according to the exemplary embodiment;

FIG. 3 is a block diagram showing a circuit configuration example of a high-frequency module disclosed in Japanese Unexamined Patent Application Publication No. 2002-141827;

FIG. 4 is a block diagram showing a circuit configuration example of a high-frequency module disclosed in Japanese Unexamined Patent Application Publication No. 2006-211199; and

FIG. 5 is a transparent perspective view showing a circuit configuration example of the high-frequency module disclosed in Japanese Unexamined Patent Application Publication No. 2006-211199.

### DETAILED DESCRIPTION OF THE EXEMPLARY EMBODIMENTS

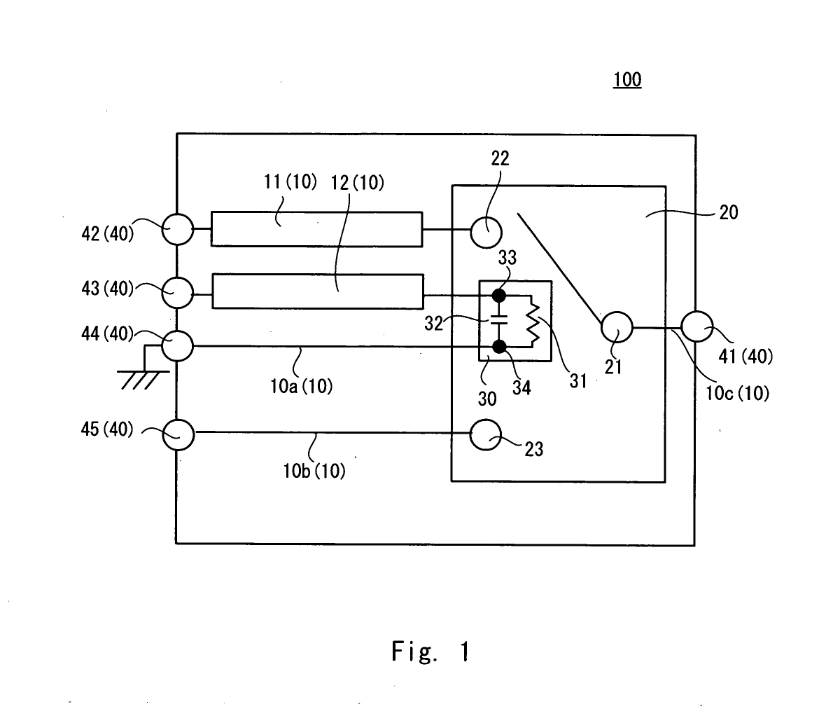

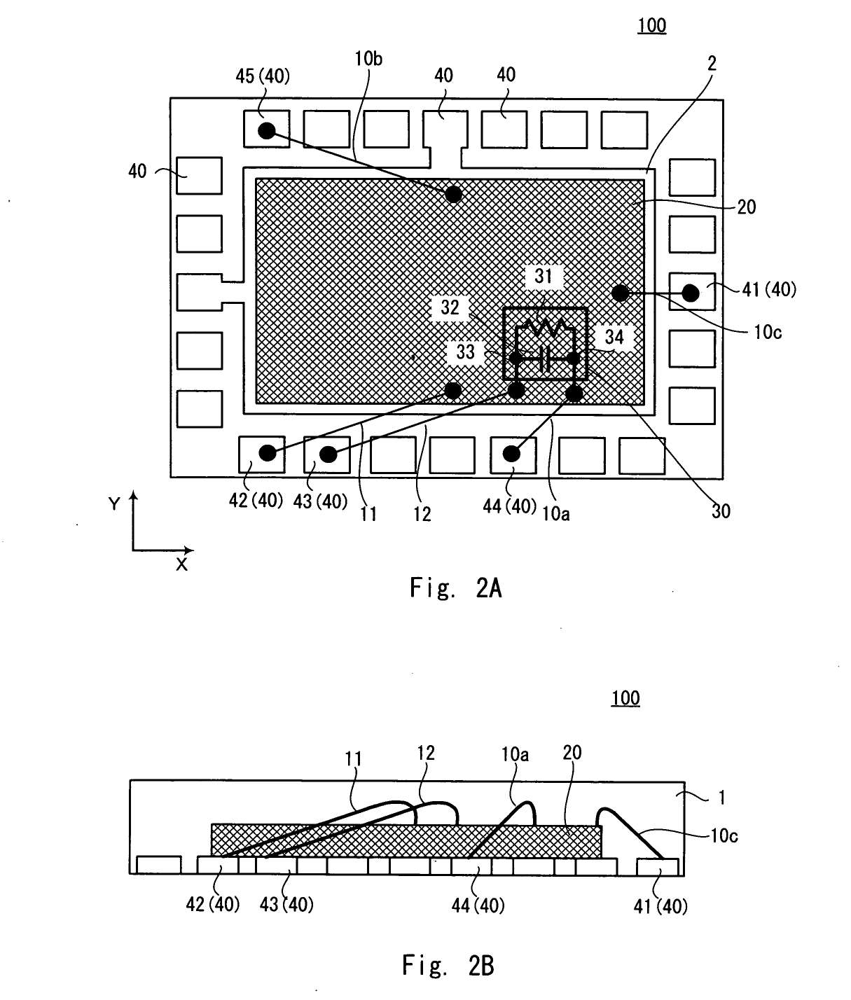

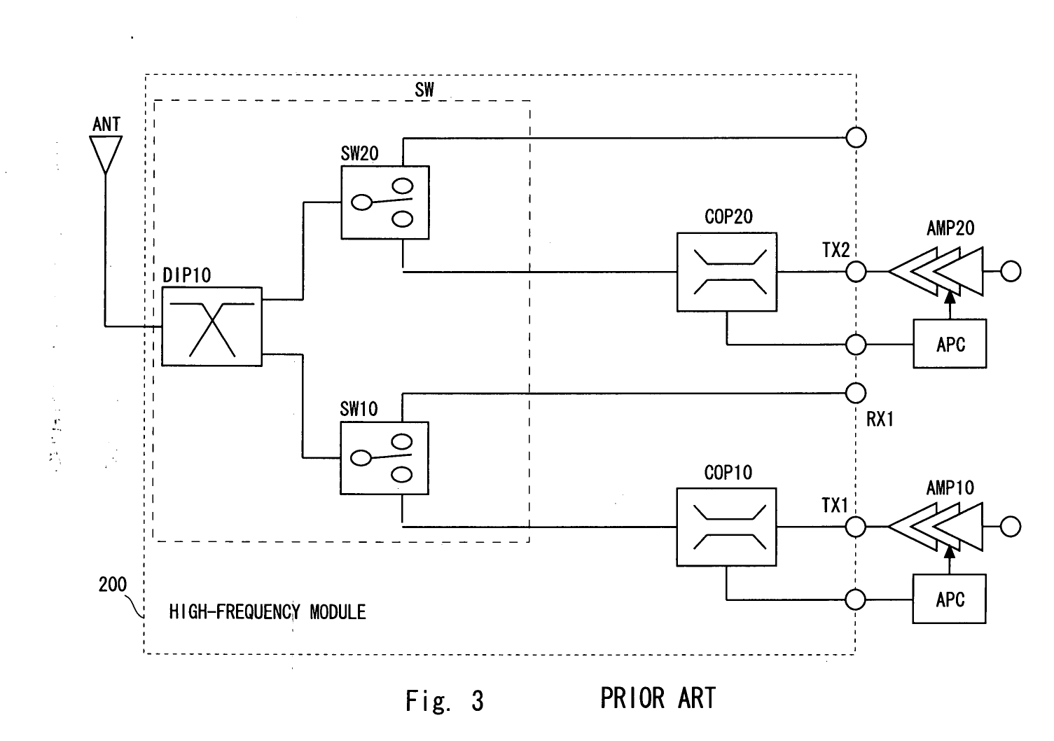

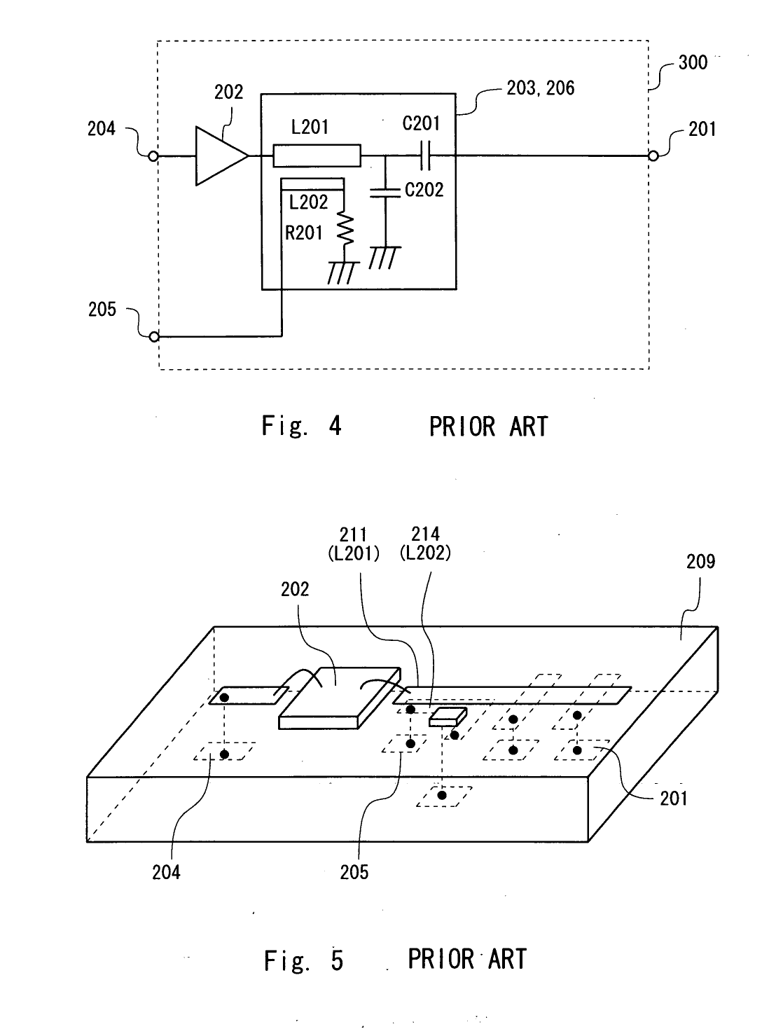

Hereinafter, one example of the exemplary embodiment to which the present invention is applied will be described. FIG. 1 is a block diagram showing a circuit configuration example of an antenna switch mounted to a radio communication device according to the exemplary embodiment. FIG. 2A shows a schematic plane view showing an assembled configuration example of the antenna switch according to the exemplary embodiment, and FIG. 2B shows a transparent side view showing an assembled configuration example of the antenna switch according to the exemplary embodiment.

The antenna switch 100 includes, as shown in FIGS. 1, 2A, and 2B, a sealed resin 1, a lead frame 2, bonding wires 10, a semiconductor chip 20, a directional coupler terminal circuit 30, external terminals 40 which are external electrodes, and the like.

The antenna switch 100 has, as shown in FIGS. 2A and 2B, a packaging structure sealed by the sealed resin 1. The semiconductor chip 20 is mounted on the lead frame 2 which is slightly larger than the semiconductor chip 20 in a planar view (see FIG. 2A). The lead frame 2 is connected to a part of a plurality of external terminals 40. One principal surface of the external terminals 40 and terminals formed in the semiconductor chip 20 are connected by the bonding wires 10. The other surface, which is the opposite side of the external terminals 40 to which the bonding wires 10 are connected, is formed so as to be exposed from the sealed resin 1.

The bonding wire 10 includes at least bonding wires 10a, 10b, 10c, and a directional coupler primary bonding wire 11 and a directional coupler secondary bonding wire 12 that are adjacent to each other. The directional coupler primary bonding wire 11 and the directional coupler secondary bonding wire 12 function as directional coupler devices.

The semiconductor chip 20 includes a first terminal 21, a second terminal 22, a third terminal 23, and the directional coupler terminal circuit 30. The directional coupler terminal circuit 30 includes a 50 Ω resistor 31, a capacitor 32, a first node 33, and a second node 34. A plurality of external terminals 40 are formed in the outer periphery of the packaging structure of the antenna switch 100. The external terminal 40 at least includes a common terminal 41, a transmission signal terminal 42, a transmission signal monitor terminal 43, a GND terminal 44, and a reception signal terminal 45.

The antenna switch 100 selectively connects one of the transmission signal terminal 42 and the reception signal terminal 45 to the common terminal 41 connected to an antenna (not shown), and is used for high-frequency application such as microwave. The common terminal 41 is connected to the first terminal 21 of the semiconductor chip 20 through the bonding wire 10c (see FIG. 1). The transmission signal terminal 42 is connected to the second terminal 22 of the semiconductor chip 20 through the directional coupler primary bonding wire 11. The reception signal terminal 45 is connected to the third terminal 23 of the semiconductor chip 20 through the bonding wire 10b (see FIG. 1).

The transmission signal monitor terminal 43 is connected to the directional coupler terminal circuit 30 through the directional coupler secondary bonding wire 12. The transmission signal monitor terminal 43 is to extract the signal to a monitor circuit (not shown) in order to control transmission output level from the transmission input terminal 42 or to protect excessive output. The GND terminal 44 is connected to an external part of the antenna switch 100, and is connected to the directional coupler terminal circuit 30 through the bonding wire 10a.

By connecting the first terminal 21 and the second terminal 22 in the semiconductor chip 20, the common terminal 41 and the transmission signal terminal 42 are connected through the directional coupler primary bonding wire 11. In the same way, by connecting the first terminal 21 and the third terminal 23 in the semiconductor chip 20, the common terminal 41 and the reception signal terminal 45 are connected through the bonding wire 10b. In other words, connection to the transmission signal terminal 42 and connection to the reception signal terminal 45 are switched depending on which of the second terminal 22 and the third terminal 23 the first terminal 21 is connected to. The 50 Ω resistor 31 is arranged between the first node 33 and the second node 34. Similarly, the capacitor 32 is also arranged between the first node 33 and the second node 34. In other words, in the directional coupler terminal circuit 30, the 50 Ω resistor 31 and the capacitor 32 are connected in parallel. The first node 33 is connected to the transmission signal monitor terminal 43 through the directional coupler secondary bonding wire 12. On the other hand, the second node 34 is connected to the GND terminal 44 through the bonding wire 10a.

The directional coupler primary bonding wire 11 is arranged to extend in a direction different from X direction or Y direction shown in FIG. 2A. Similarly, the directional coupler secondary bonding wire 12 is also arranged to extend in a direction different from X direction or Y direction shown in FIG. 2A. Then, these two bonding wires are arranged to be substantially parallel with each other. Such an arrangement of the bonding wires realizes long line length of the directional couplers, and maximizes the functions of the directional couplers.

The transmission signal terminal 42 to which one end of the directional coupler primary bonding wire 11 is connected, and the transmission signal monitor terminal 43 to which one end of the directional coupler secondary bonding wire 12 is connected are provided so as to be adjacent to each other, as shown in FIGS. 2A and 2B. Accordingly, the directional coupler primary bonding wire 11 and the directional coupler secondary bonding wire 12 can be arranged so as to be close to each other. Although description has been made in the example of FIG. 2A that the transmission signal terminal 42 and the transmission signal monitor terminal 43 are arranged in the same side of the outer periphery of the antenna switch 100, they are not necessarily arranged as such, but they may be arranged in different sides that are adjacent to each other.

The transmission signal input from the transmission signal terminal 42 is connected, as shown in FIG. 1, to the second terminal 22 in the semiconductor chip 20 through the directional coupler primary bonding wire 11. At this time, a part of the transmission signal appears as a sufficient monitoring signal in the transmission signal monitor terminal 43 through the directional coupler secondary bonding wire 12 by electromagnetic-field coupling of the directional coupler primary bonding wire 11 with the directional coupler secondary bonding wire 12.

Further, there is generated directionality in this electromagnetic-field coupling by providing the 50 Ω resistor 31 in the directional coupler terminal circuit 30 formed on the semiconductor chip 20. Further, adjustment of the frequency that requires the directionality is made possible by the wavelength shortening effect by the capacitor 32 of the directional coupler terminal circuit 30.

In the high-frequency module 300 disclosed in the above-stated Japanese Unexamined Patent Application Publication No. 2006-211199, a wiring conductive layer is formed as a strip line on a dielectric layer. In this case, there is limitation in the size of the device that is required to form the directional coupler due to the limitation in thickness of the dielectric layer or the limitation in the minimum interval of the strip line. This makes it difficult to realize further downsizing.

On the other hand, in the exemplary embodiment, two of the bonding wires in the antenna switch 100 are used as the lines of the directional couplers, whereby the distance between the primary line and the secondary line of the directional couplers can be reduced. Further, sufficient coupling property can be obtained with the downsized lines. In summary, by incorporating the directional couplers in the antenna switch, downsizing is realized in the radio communication device.

Further, line length of the bonding wires used for the directional couplers can be set longer by arranging the wires to be oblique so as to be different from the X direction or Y direction shown in FIG. 2A. Further, as the structure is employed in which the bonding wires are formed by arranging the transmission signal terminal and the transmission signal monitor terminal so that they are arranged to be adjacent to each other, two directional couplers can be made dramatically close to each other compared with the related method in which the wiring conductive layer is formed as the strip line on the dielectric layer. In other words, it is possible to form minute directional couplers inside the antenna switch 100. In addition, there is also an advantage that the directional couplers can be manufactured without extra special manufacturing processes.

According to the present invention, by employing the above structure, the directional couplers can be formed inside the antenna switch 100, whereby it is possible to provide a radio communication device that can realize downsizing and cost reduction compared with the related structure. In addition, there is an advantage that the conductor is not required on the dielectric layer to form the directional couplers.

Needless to say, the present invention is not limited to the above-described exemplary embodiment, but other exemplary embodiments may be within the scope of the present invention without departing from the spirit of the present invention. For example, a circuit that includes other functions such as an amplifier may be provided in the semiconductor chip 20 mounted to the antenna switch 100. Further, although description has been made with the example of the antenna switch having the packaging structure sealed by the sealed resin 1, the antenna switch may not have the packaging structure formed with the sealed resin.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. An antenna switch that selectively connects one of a transmission signal terminal and a reception signal terminal to a common terminal connected to an antenna, the antenna switch comprising:
a plurality of external terminals including the common terminal, the transmission signal terminal, and the reception signal terminal;
a semiconductor chip having a plurality of terminals formed therein; and
a plurality of bonding wires that connect the external terminals and the plurality of terminals formed in the semiconductor chip, wherein
two bonding wires that are adjacent to each other among the plurality of bonding wires are used as directional couplers.

2. The antenna switch according to claim 1, wherein the bonding wires that form the directional couplers comprise:
a bonding wire that connects the transmission signal terminal to which a transmission signal is input and a terminal formed in the semiconductor chip; and
a bonding wire that connects a transmission signal monitor terminal arranged in a position adjacent to the transmission signal terminal and a terminal formed in the semiconductor chip.

3. The antenna switch according to claim 2, wherein the transmission signal terminal and the transmission signal monitor terminal are arranged so as to be apart from the terminals of the semiconductor chip connected to the bonding wires so that distance of the bonding wires that form the directional couplers becomes long.

4. The antenna switch according to claim 1, wherein the two bonding wires that are used for the directional couplers are arranged substantially in parallel with each other.

5. The antenna switch according to claim 2, wherein the two bonding wires that are used for the directional couplers are arranged substantially in parallel with each other.

6. The antenna switch according to claim 3, wherein the two bonding wires that are used for the directional couplers are arranged substantially in parallel with each other.

7. The antenna switch according to claim 1, wherein the semiconductor chip, the bonding wires, and the external terminals have a packaging structure sealed by a sealed resin.

8. The antenna switch according to claim 1, wherein the semiconductor chip comprises a directional coupler terminal circuit that includes at least a resistor.

9. The antenna switch according to claim 2, wherein the semiconductor chip comprises a directional coupler terminal circuit that includes at least a resistor.

10. The antenna switch according to claim 3, wherein the semiconductor chip comprises a directional coupler terminal circuit that includes at least a resistor.

11. A radio communication device that includes an antenna switch, wherein
the antenna switch selectively connects one of a transmission signal terminal and a reception signal terminal to a common terminal connected to an antenna,
the antenna switch comprises:
a plurality of external terminals including the common terminal, the transmission signal terminal, and the reception signal terminal;
a semiconductor chip having a plurality of terminals formed therein; and
a plurality of bonding wires that connect the external terminals and the plurality of terminals formed in the semiconductor chip, and
two bonding wires that are adjacent to each other among the plurality of bonding wires are used as directional couplers.

12. The radio communication device according to claim 11, wherein the bonding wires that form the directional couplers comprise:
a bonding wire that connects the transmission signal terminal to which a transmission signal is input and a terminal formed in the semiconductor chip; and
a bonding wire that connects a transmission signal monitor terminal arranged in a position adjacent to the transmission signal terminal and a terminal formed in the semiconductor chip.

13. The radio communication device according to claim 12, wherein the transmission signal terminal and the transmission signal monitor terminal are arranged so as to be apart from the terminals of the semiconductor chip connected to the bonding wires so that distance of the bonding wires that form the directional couplers becomes long.

14. The radio communication device according to claim 11, wherein the two bonding wires that are used for the directional couplers are arranged substantially in parallel with each other.
